(19) United States
(12) Patent Application Publication
(10) Pub. No.: US 2005/0102376 A1
(43) Pub. Date: May 12, 2005

(54) Image-correction processing apparatus and program

(76) Inventor: Koji Ichikawa, Asaka-shi (JP)

Correspondence Address: BIRCH STEWART KOLASCH & BIRCH, PO BOX 747, FALLS CHURCH, VA, 22040-0747, US

(21) Appl. No.: 10/669,608

(22) Filed: Sep. 25, 2003

(30) Foreign Application Priority Data
Sep. 26, 2002 (JP) 2002-281280

(51) Int. Cl. G06F 15/16; H04Q 7/20

(52) U.S. Cl. 709/219; 455/466; 709/206

(57) ABSTRACT

An image sending server receives an image, which is picked up by a sender cellular phone as a destination terminal and is requested to send, as a pre-sending image via a network, and stores the image in a send-out image storing portion. A destination terminal information inputting portion inputs destination terminal information acquired from a destination cellular phone, and transfers the information to a send-out image generation processing portion. The send-out image generation processing portion generates the send-out image by performing an image correcting process according to characteristics of each image and also performing an image correcting process, which is adaptive for the model of the destination cellular phone, according to image-correction parameter, which is appropriate for a display device of the destination cellular phone based on the destination terminal information. This send-out image is sent from an image transmitting portion to the destination cellular phone via the network.

### BACKGROUND OF THE INVENTION

1. Field of the Invention

The present invention relates to an image-correction processing apparatus and a program for performing an image correcting process for an image in an image sending system that sends images to destination terminals.

2. Description of the Related Art

In recent years, through the spread of the digital camera and with the advent of the cellular phone with a camera, the picked-up image is transmitted as an attached file of the electronic mail or an image data file to the other mobile terminal such as cellular phone, PDA (Personal Digital Assistance), a personal computer (abbreviated as a “PC” hereinafter), etc. to display.

In such an image sending system, the image correcting process, which automatically corrects brightness, white balance, etc. of the send-out image picked up the digital camera or the cellular phone with the camera in the system every image, may be performed in such a manner that even the image picked up at the inadequate exposure or white balance can be displayed appropriately on the destination terminal. In the image correcting process of this case, normally the correction that intends to display appropriately the image on the standard monitor, which is defined by the sRGB standard, is executed on the premise that the image is displayed on the monitor of PC.

As an example of the image sending system in a related art, there is a system that sends the image data, which are processed for the display screen of the desired cellular phone, by utilizing the network (see JP-A-2001-345985, for example). In this example, the image processing terminal connected to the network, works/processes the read image data based on the cellular phone information, which are input by the ordering person, according to a size of the display screen, the number of colors that can be displayed, etc., and then sends such image data to the designated cellular phone via the image accumulating server and the service server.

As mentioned above, JP-A-2001-345985 (pages 2 to 7, FIG. 1) is known as a related art.

In a terminal having an image displaying function using a small-size display device such as the cellular phone or the like, characteristics such as color reproduction, tone reproduction, color temperature, sharpness and etc. are largely different every model. Therefore, in the case that the image is sent to a cellular phone as the destination terminal, even if the image optimized on the premise that the image is displayed on the monitor of PC is sent, the image is not always preferably displayed according to the model of the destination terminal.

Also, in the example of the above image sending system, the ordering person as the sender inputs display screen information such as the size, the number of colors that can be displayed, etc. of the display screen of the destination terminal into the image processing terminal in the system, and therefore the image correcting process is not automatically performed according to the model of the destination terminal. As a result, the destination terminal information must always be managed in the sender terminal, etc., and thus the problem existed in a respect of convenience.

### SUMMARY OF THE INVENTION

The present invention has been made to overcome the above problems. An object of the present invention is to provide an image-correction processing apparatus and a program, capable of sending an image which is corrected such that the image can be displayed in appropriate picture quality according to the model of a destination terminal, without recognition of a display device of the destination terminal, when the image is sent to the destination terminal.

The invention provides an image-correction processing apparatus in an image sending system that sends an image to a destination terminal via a network, having: terminal information acquiring means for acquiring a destination terminal information about the destination terminal; and send-out image generating means for generating a send-out image by performing an image correcting process, which corresponds to a model of the destination terminal, based on the destination terminal information.

The invention also provides an image-correction processing apparatus in an image sending system that sends an image to a destination terminal via a network, having: a terminal information acquiring portion which acquires a destination terminal information about the destination terminal; and a send-out image generator which generates a send-out image by performing an image correcting process, which corresponds to a model of the destination terminal, based on the destination terminal information.

According to the above configuration, since the appropriate image correcting process that is appropriate for the model of the destination terminal can be performed, the sender can send the image without recognition of model of the destination terminal, model, characteristics, etc. of the display device, and can send the send-out image that is corrected in such a way that the image can be displayed in appropriate picture quality according to the model of the destination terminal.

Furthermore, the send-out image generating means includes: first image-correction processing means for performing an image correcting process according to each image for a pre-sending image; and second image-correction processing means for performing an image correcting process which is respectively appropriate for each model of the destination terminal after the image correcting process performed by the first image-correction processing means.

Furthermore, the send-out image generator includes: a first image-correction processor which performs an image correcting process according to each image for a pre-sending image; and a second image-correction processor which performs an image correcting process which is respectively appropriate for each model of the destination terminal after the image correcting process performed by the first image-correction processor.

According to the above configuration, since the image correcting processes such as color reproduction, tone reproduction, color temperature, sharpness, etc. are performed according to the display device characteristics of the model of the destination terminal, etc. in addition to the image correcting processes such as brightness, white balance, sharpness, noise cancellation, etc. according to the characteristics of respective send-out images, etc., the send-out image that is appropriate for the model of the destination terminal can be generated. Also, when the image is sent to the terminal such as PC, etc., the extra process can be reduced by the image correcting process using the first image-correction processing means only, and thus the image correcting process that is suited for the destination terminal can be performed.

Furthermore, the image-correction processing apparatus further has: image-correction parameter storing means for storing image-correction parameters of each model of the destination terminal; and image-correction parameter setting means for setting an image-correction parameter used for the image correcting process performed by the second image-correction processing means, which is appropriate for a model of the destination terminal, based on the destination terminal information.

Furthermore, an image-correction parameter memory which stores image-correction parameters of each model of the destination terminal; and an image-correction parameter setting portion which sets an image-correction parameter used for the image correcting process performed by the second image-correction processor, which is appropriate for a model of the destination terminal, based on the destination terminal information.

According to the above configuration, the image correcting process that is appropriate for the model of the destination terminal can be performed with good precision by using the image-correction parameter that are set based on the destination terminal information.

Furthermore, the terminal information acquiring means acquires the destination terminal information from the destination terminal, and the image-correction parameter setting means selects an image-correction parameter corresponding to a destination terminal information, which is acquired by the terminal information acquiring means, from the image-correction parameters stored in the image-correction parameter storing means.

Furthermore, the terminal information acquiring portion acquires the destination terminal information from the destination terminal, and the image-correction parameter setting portion selects an image-correction parameter corresponding to a destination terminal information, which is acquired by the terminal information acquiring portion, from the image-correction parameters stored in the image-correction parameter memory.

According to the above configuration, since the destination terminal information are acquired at the time of sending the image and then the image-correction parameter that are adaptive for the destination terminal information are selected/set, the image-correcting parameter can be set appropriately.

The invention provides an image-correction processing program which is executed by a computer to implement functions of respective means in the image-correction processing apparatus.

According to the above program, since the appropriate image correcting process that is appropriate for the model of the destination terminal can be performed, the sender can send the image without recognition of model of the destination terminal, model, characteristics, etc. of the display device. The send-out image can be displayed on the destination terminal in appropriate picture quality according to the characteristics of the installed display device.

### BRIEF DESCRIPTION OF THE DRAWINGS

FIG. 1 is a block diagram showing a schematic configuration of an image sending system according to an embodiment of the present invention;

FIG. 2 is a block diagram showing a functional structure of a send-out image generation processing portion in an image sending server in the present embodiment;

FIG. 3 is a block diagram showing a pertinent configuration of a destination cellular phone in the image sending system in the present embodiment; and

FIG. 4 is a flowchart showing operational procedures carried out when the image is sent to the destination cellular phone by the image sending server.

### DETAILED DESCRIPTION OF THE PREFERRED EMBODIMENTS

An embodiment of the present invention will be explained with reference to the drawings hereinafter. In the present embodiment, as an example of an image sending system, a configurative example of an image-correction processing apparatus in a system that sends an image, which is picked up by a cellular phone with a camera, to other cellular phone is shown. In this case, an image-correction processing program according to the present invention causes a computer to implement respective functions in the image-correction processing apparatus.

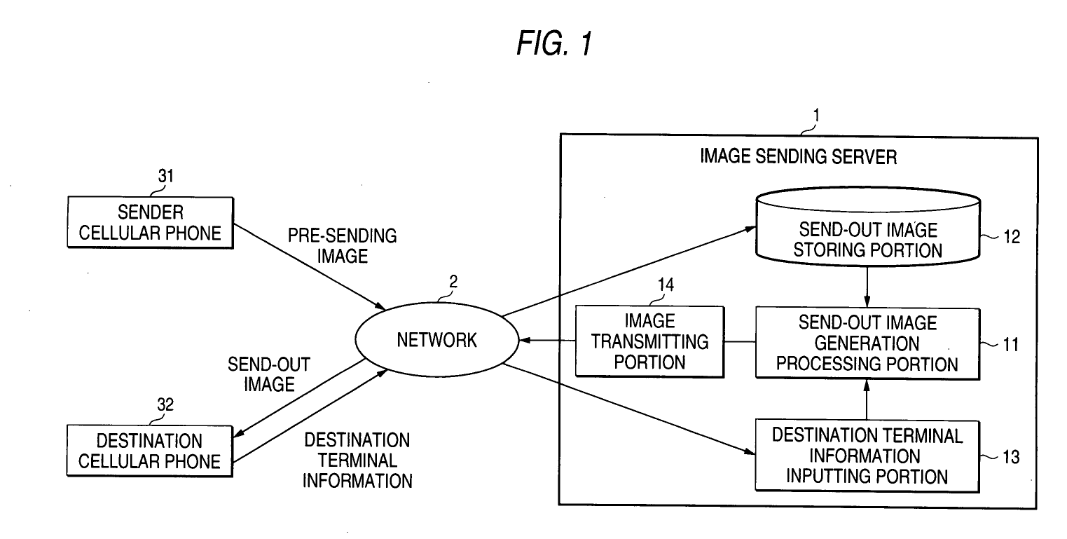

FIG. 1 is a block diagram showing a schematic configuration of an image sending system according to an embodiment of the present invention.

The image sending system of the present embodiment includes an image sending server 1 having a function as an image-correction processing apparatus which is connected to a mobile communication system or a network 2 such as the Internet, etc., a sender cellular phone 31 such as a cellular phone with a camera, etc. as a sender terminal, and a destination cellular phone 32 as a destination terminal. In this image sending system, an image to be sent such as an the image picked up by the sender cellular phone 31 is sent from the image sending server 1 to the destination cellular phone 32. In this case, in the present embodiment, the sender terminal and the destination terminal are explained while taking the cellular phone as an example, but these terminals are not limited to this. If the terminal can access the image sending server 1 via the network 2, any terminal such as PDA, PC, etc., for example, may be employed.

The image sending server 1 has a send-out image generation processing portion 11, a send-out image storing portion 12, a destination-terminal information inputting portion 13, and an image transmitting portion 14. The send-out image generation processing portion 11 generates an image to be set out (send-out image) by performing an appropriate image correcting process for a pre-sending image, which is transferred from the sender cellular phone 31 in reply to the sending request, according to the model of the destination cellular phone 32. The send-out image storing portion 12 stores the pre-sending image transferred from the sender cellular phone 31. The destination-terminal information inputting portion 13 acquires terminal information of the destination cellular phone 32. The image transmitting portion 14 sends the send-out image to the destination cellular phone 32.

The image sending server 1 receives pre-sending image data to be distributed and then stores in the send-out image storing portion 12 when the effect that the picked-up image, etc. are sent to the destination cellular phone 32 is required from the sender cellular phone 31 via the network 2. Also, the image sending server 1 acquires the terminal information of the destination cellular phone 32 by the destination-terminal information inputting portion 13. Then, the send-out image generation processing portion 11 generates the send-out image by performing the appropriate image correcting process which is appropriate for the destination cellular phone 32 based on the image-correction parameter corresponding to the acquired destination terminal information. Then, the image transmitting portion 14 sends out the send-out image to the destination cellular phone 32 via the network 2.

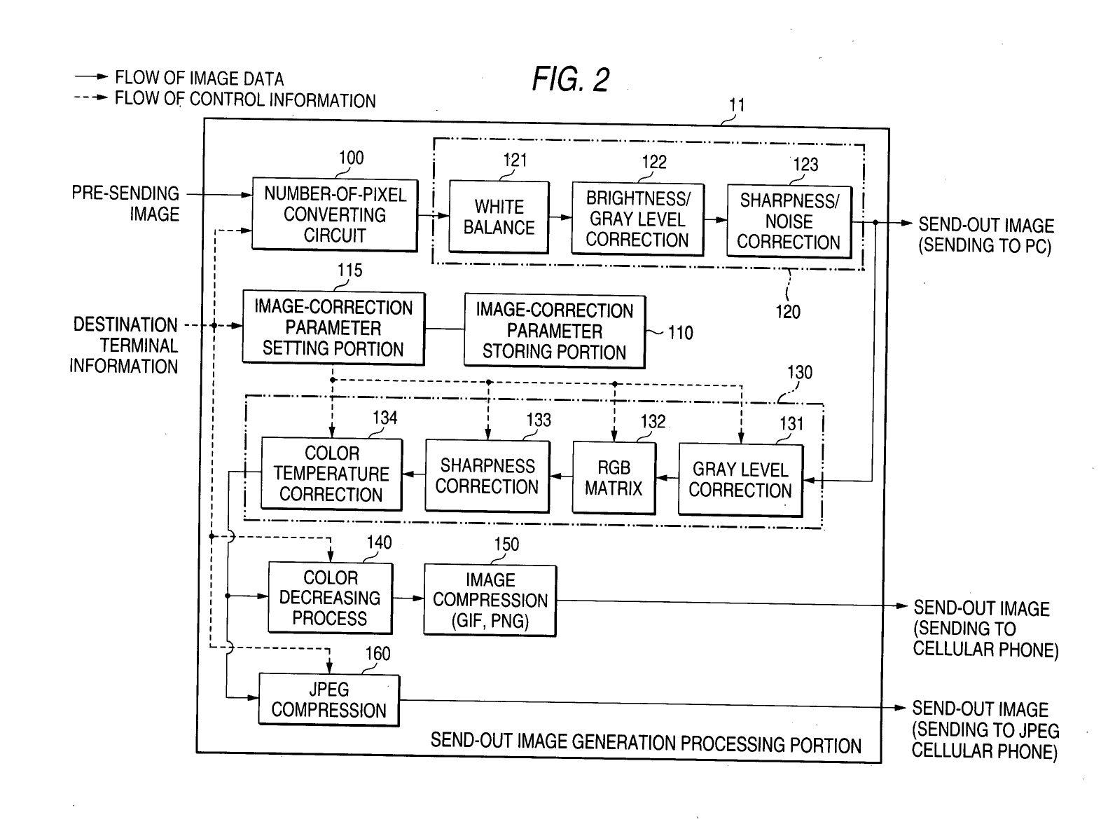

FIG. 2 is a block diagram showing a functional structure of the send-out image generation processing portion 11 in the image sending server 1 in the present embodiment. In FIG. 2, a flow of image data is indicated by a solid-line with an arrow, and a flow of control information is indicated by a broken-line with an arrow.

The send-out image generation processing portion 11 has a number-of-pixel converting circuit 100, an image-correction parameter storing portion 110, an image-correction parameter setting portion 115, a first image-correction processing portion 120, a second image-correction processing portion 130, a color-decrease processing circuit 140, an image compressing circuit 150, and a JPEG compressing circuit 160. The number-of-pixel converting circuit 100 converts the number of pixels constituting an image to be appropriate for a display screen size of the destination terminal. The image-correction parameter storing portion 110 stores image-correction parameter corresponding to characteristics of the display device every model of the destination terminal. The image-correction parameter setting portion 115 reads the image-correction parameter, which corresponds to the destination terminal information acquired from the destination terminal, from the image-correction parameter storing portion 110 and sets the read image-correction parameter to the second image-correction processing portion 130. The first image-correction processing portion 120 performs an image correcting process for the pre-sending image transferred from the sender terminal to generate the standard send-out image. The second image-correction processing portion 130 performs an image correcting process based on the image-correcting parameter set by the image-correction parameter setting portion 115 according to the model of the destination terminal to generate the send-out image which is suited for the display device of the destination terminal. The color-decrease processing circuit 140 performs a color decreasing process to match with the number of colors that can be displayed on the destination terminal. The image compressing circuit 150 performs a compression process for send-out image data in the compression format such as GIF, PNG, or the like. The JPEG compressing circuit 160 performs the compression process for the send-out image data in the JPEG format.

The first image-correction processing portion 120 for performing an image correcting process such as picture quality correction, or the like in response to each image has a white balance circuit 121 for correcting color data of each pixel into a value that responds to a color temperature of a light source at the time of imaging, a brightness/gray level correcting circuit 122 for correcting the brightness and the gray level of the display image in response to characteristics of the display device, and a sharpness/noise correcting circuit 123 for canceling noise components contained in the image to perform a sharpness process.

The second image-correction processing portion 130 for performing the image correcting process such as picture quality correction, or the like, which is suited for each model of the destination terminal, has a gray-level correcting circuit 131 for performing a gray level correction by using a look-up table (LUT) that meets to the gamma characteristic of the display device of the destination terminal, an RGB matrix circuit 132 for performing a matrix operation (e.g., 3×3 matrix operation) of respective color data of RGB to correct a hue and a saturation, a sharpness correcting circuit 133 for adjusting an intensity of sharpness, and a color-temperature correcting circuit 134 for correcting the color temperature.

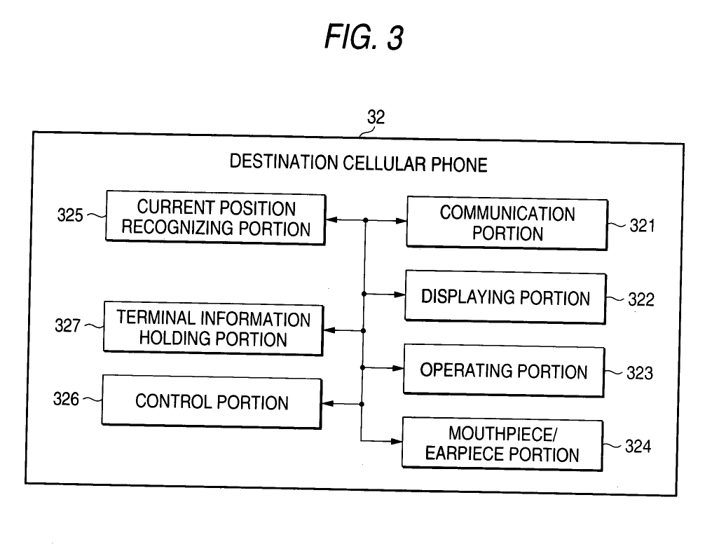

FIG. 3 is a block diagram showing a pertinent configuration of the destination cellular phone 32 in the image sending system in the present embodiment.

The destination cellular phone 32 has a communicating portion 321, a displaying portion 322, an operating portion 323, a mouthpiece/earpiece portion 324, a current position recognizing portion 325, a controlling portion 326, and a terminal information holding portion 327. The communicating portion 321 performs modulation/demodulation and transmission/reception of the radio signal. The displaying portion 322 consists of a display device that has a liquid crystal display and its driving circuit to display communication information, received image, etc. The operating portion 323 consists of a group of buttons that are used to input a phone number and characters and designate/select the image data. The mouthpiece/earpiece portion 324 has a microphone, a speaker, and a voice signal processing circuit to transmit/receive the phone conversation. The current position recognizing portion 325 acquires position information based on signals that are emitted from the GPS satellite and the base station. The controlling portion 326 has a CPU, a memory, etc. to control respective portions and perform the signal processing. The terminal information holding portion 327 holds terminal information such as a display capability, a display characteristic, etc. of the display device that is installed into the destination cellular phone 32.

The destination cellular phone 32 receives the request issued from the image sending server 1, then reads the terminal information from the terminal information holding portion 327 to transmit the read terminal information. Also, the destination cellular phone 32 receives the image data which is sent from the image sending server 1 and is subjected to the image correcting process that is suitable for the destination cellular phone 32, and then displays the image data on the displaying portion 322.

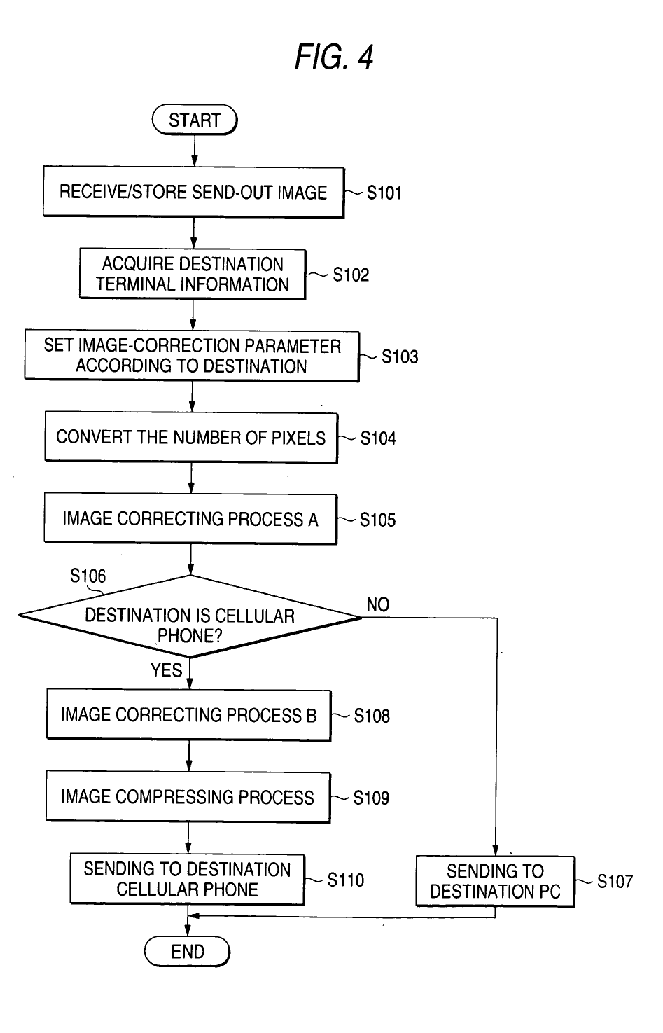

Next, operations of the image sending system of the present embodiment, mainly an operation of the send-out image generation processing portion 11 will be explained hereunder. FIG. 4 is a flowchart showing operational procedures carried out when the image is sent to the destination cellular phone 32 by the image sending server 1.

First, the image sending server 1 receives the image data of the pre-sending image such as the picked-up image that is transferred from the sender cellular phone 31, etc., and stores such image data in the send-out image storing portion 12 (step S101) . At this time, when the destination terminal is designated previously by the sender cellular phone 31 such that the image data are transmitted in the electronic mail format, etc., the image sending server 1 also receive destination information such as the mail address of the destination terminal, the network address, etc. together, and stores them.

Then, the destination terminal information of the destination cellular phone 32 as the destination terminal is acquired (step S102). Here, when the send-out image is acquired by accessing to the network from the destination cellular phone 32, the image sending server 1 transmits the sending information to the destination cellular phone 32 via the electronic mail, or the like to inform of the presence of the send-out image and the address such as URL, which indicates the image sending location to get the send-out image, etc., and also to request the terminal information containing the specification of the display device of the destination cellular phone 32, etc. In response to this, the destination cellular phone 32 replies the destination terminal information to the image sending server 1. In contrast, when the send-out image is directly transferred to the destination cellular phone 32 from the image sending server 1, the terminal information request is transmitted to the destination cellular phone 32, and then the destination terminal information that are replied from the destination cellular phone 32 are acquired.

Then, image-correction parameter that corresponds to the destination cellular phone 32 are set based on the acquired destination terminal information (step S103). At this time, the image-correction parameter that corresponds to the destination terminal information is selected from the image-correction parameter, which are stored in advance every model, by looking up the image-correction parameter storing portion 110. Otherwise, the image-correction parameter that is adaptive to the destination cellular phone 32 may be generated based on the destination terminal information, and then stored in the image-correction parameter storing portion 110.

Then, the number-of-pixel converting process that corresponds to the constituent pixel number of the liquid crystal display of the destination cellular phone 32 is carried out in the number-of-pixel converting circuit 100 (step S104). Accordingly, a resize of the pre-sending image is conducted to coincide with a display screen size of the destination cellular phone 32.

Then, an automatic image correcting process that is suited for the concerned image (also referred to as “an image correcting process A” hereinafter) is performed for the pre-sending image in the first image-correction processing portion 120 (step S105). In this image correcting process A, the image correcting process is performed by analyzing the image data obtained after the number-of-pixel converting process is performed, and then deciding automatically a quantity of correction to have the picture quality enough for the display device of the standard PC based on the sRGB standard. First, the color correction for white balance adjustment is performed in the white balance circuit 121, and brightness and gray level correction of the image is performed in the brightness/gray level correcting circuit 122. Also, cancellation of the noise that is superposed in the course of the signal processing and adjustment of the sharpness intensity of the image are performed in the sharpness/noise correcting circuit 123.

When the automatic image correcting process performed in the first image-correction processing portion 120 in response to each image (the image correcting process A) is ended, it is checked whether or not the destination terminal is the cellular phone (step S106) . As a result, unlike the example in FIG. 1, if the destination terminal is PC, for example, the image correcting process that is suited for each model of the destination terminal is not needed. Therefore, the image data that was subjected to the image correcting process A are transferred to the destination PC as the send-out image (step S107).

On the contrary, like the present embodiment, if it is decided in step S106 that the destination terminal is the cellular phone, an image correcting process that corresponds to the display device characteristic (also referred to as “an image correcting process B” hereinafter) is applied to the pre-sending image every model of the destination terminal based on the image-correction parameter, which is set in the image-correction parameter storing portion 110 and is adaptive to the destination cellular phone 32, in the second image-correction processing portion 130 (step S108).

In this image correcting process B, first the gray level correction is performed in the gray-level correcting circuit 131 by using a look-up table that corresponds to the gamma characteristic of the display device of the destination cellular phone 32. Then, the hue and the saturation are corrected by performing the matrix operation of respective color data of RGB constituting the image in the RGB matrix circuit 132. Then, the sharpness intensity of the image is adjusted in the sharpness correcting circuit 133, and also the color balance is adjusted by correcting the color temperature in the color-temperature correcting circuit 134 to get the reddish image or the bluish image as the appropriate image, for example.

In this manner, when the image correcting process that is performed in the second image-correction processing portion 130 and is suited for every model of the destination terminal (the image correcting process B) is ended, a compressing process of the image data is performed (step S109). This image compressing process is performed by selecting the compression format, which can be handled in the destination cellular phone 32, based on the acquired destination terminal information. For example, if the image data is compressed in the compression format such as GIF, PNG, etc., the number of colors is converted into the number of colors, which can be displayed on the destination cellular phone 32, by using a color-decreasing color pallet in the color-decrease processing circuit 140, then the compressing process is performed by converting the image into the image data format such as GIF, PNG, or the like in the image compressing circuit 150. In contrast, if the image data is compressed in the JPEG format, the color decreasing process is not performed on the sending side because the terminal that is able to display the JPEG data has a color decreasing function. Thus, the compressing process is performed in the JPEG compression 160 at a predetermined compression ratio to get a quantity of data that corresponds to the model of the destination cellular phone 32.

Then, the image data obtained after the image compressing process are sent as the send-out image from the image transmitting portion 14 to the destination cellular phone 32 via the network 2 (step S110).

The destination cellular phone 32 receives the send-out image by the communicating portion 321 via the network 2, and then displays such send-out image in the displaying portion 322. At this time, the send-out image to which picture quality correcting processes such as brightness, color reproduction, tone reproduction, sharpness, noise cancellation, etc. are adequately executed is displayed in the optimum picture quality on the liquid crystal display of the displaying portion 322.

As described above, according to the present embodiment, when an image picked up by the sender cellular phone 31 is sent from the image sending server 1 to the destination cellular phone 32 via the network 2, the image sending server 1 sends an image with the picture quality, which is optimum to display on the destination cellular phone 32, by performing automatically the image correcting processes, which are suited for the destination cellular phone 32, based on the image-correction parameter that is appropriate for the model of the destination terminal.

In this case, the present invention is not limited to the above embodiment at all, and various modes can be implemented in the scope without departing from the gist. In the above embodiment, the configuration and the operation of the send-out image generation processing portion 11 are explained on the premise that the image correcting process in the RGB data is performed. But the present invention may be similarly implemented in other color mode, e.g., in the process in the YcrCb data that are expressed by the luminance signal and the color difference signal.

Also, separate parameters may be stored as the image-correcting parameter every one model of the destination terminal, or the models of the destination terminals may be classified into plural groups and then the image-correction parameter may be stored every group. For example, the image-correction parameter may be classified every communication carrier company or every maker of the terminal, or the image-correcting parameter may be classified into groups every similar model whose display device characteristics are identical.

Also, in the above embodiment, the image-correction parameter for respective models may be stored previously in the image-correction parameter storing portion 110, and then the corresponding parameter may be selected based on the destination terminal information that is acquired from the destination cellular phone 32. In this case, the image-correction parameter may be acquired from the destination cellular phone 32, otherwise a plurality of image-correction parameter or the image-correction parameter for each model may be downloaded from the model database server that stores the terminal information, or the like and then the image correcting process that is suitable for each model of the destination terminal may be performed.

Also, in the above embodiment, the example in which the image being picked up by the sender cellular phone 31 is sent to the destination cellular phone 32 is explained. But the send-out image that has been sent once can be sent again from the image sending server 1 to another destination terminal. In this case, if the image correcting process is performed again for the image, which is used as the standard send-out image by performing the automatic image correcting process once in response to each image, in the first image-correction processing portion 120 of the send-out image generation processing portion 11, the picture quality is deteriorated in some cases. Therefore, it is preferable that a proper measure should be adopted, e.g., a tag should be attached, to the image, to which the automatic image correcting process is performed by the first image-correction processing portion 120, so as to indicate that the standard image correcting process has already been performed for the image, and then the automatic image correcting process in the first image-correction processing portion 120 (the image correcting process A) should not be performed or a part of the correction process should be omitted by detecting the measure at the time of re-sending.

As described above, according to the present embodiment, when the image is sent to the destination terminal, it is feasible to send the image that is corrected in such a way that the image can be displayed with appropriate picture quality according to the model of the destination terminal, without recognition of the display device of the destination terminal.

1. An image-correction processing apparatus in an image sending system that sends an image to a destination terminal via a network, comprising:
terminal information acquiring means for acquiring a destination terminal information about the destination terminal; and
send-out image generating means for generating a send-out image by performing an image correcting process, which corresponds to a model of the destination terminal, based on the destination terminal information.

2. The image-correction processing apparatus according to claim 1,
wherein the send-out image generating means includes:
first image-correction processing means for performing an image correcting process according to each image for a pre-sending image; and
second image-correction processing means for performing an image correcting process which is respectively appropriate for each model of the destination terminal after the image correcting process performed by the first image-correction processing means.

3. The image-correction processing apparatus according to claim 1, further comprising:
image-correction parameter storing means for storing image-correction parameters of each model of the destination terminal; and
image-correction parameter setting means for setting an image-correction parameter used for the image correcting process performed by the second image-correction processing means, which is appropriate for a model of the destination terminal, based on the destination terminal information.

4. The image-correction processing apparatus according to claim 3,
wherein the terminal information acquiring means acquires the destination terminal information from the destination terminal, and
the image-correction parameter setting means selects an image-correction parameter corresponding to a destination terminal information, which is acquired by the terminal information acquiring means, from the image-correction parameters stored in the image-correction parameter storing means.

5. An image-correction processing program which is executed by a computer to implement functions of respective means in the image-correction processing apparatus set forth in claim 1.

6. An image-correction processing apparatus in an image sending system that sends an image to a destination terminal via a network, comprising:
a terminal information acquiring portion which acquires a destination terminal information about the destination terminal; and
a send-out image generator which generates a send-out image by performing an image correcting process, which corresponds to a model of the destination terminal, based on the destination terminal information.

7. The image-correction processing apparatus according to claim 6,
wherein the send-out image generator includes:
a first image-correction processor which performs an image correcting process according to each image for a pre-sending image; and
a second image-correction processor which performs an image correcting process which is respectively appropriate for each model of the destination terminal after the image correcting process performed by the first image-correction processor.

8. The image-correction processing apparatus according to claim 6, further comprising:
an image-correction parameter memory which stores image-correction parameters of each model of the destination terminal; and
an image-correction parameter setting portion which sets an image-correction parameter used for the image correcting process performed by the second image-correction processor, which is appropriate for a model of the destination terminal, based on the destination terminal information.

9. The image-correction processing apparatus according to claim 8,
wherein the terminal information acquiring portion acquires the destination terminal information from the destination terminal, and
the image-correction parameter setting portion selects an image-correction parameter corresponding to a destination terminal information, which is acquired by the terminal information acquiring portion, from the image-correction parameters stored in the image-correction parameter memory.
